(19) United States
(12) Patent Application Publication
(10) Pub. No.: US 2025/0276415 A1
(43) Pub. Date: Sep. 4, 2025

(54) MOUNTING BRACKET AND SERVER HAVING THE MOUNTING BRACKET

(71) Applicant: Fulian Precision Electronics (Tianjin) Co., LTD., Tianjin (CN)

(72) Inventors: TUNG-HO SHIH, New Taipei (TW); KUAN-CHIN YU, New Taipei (TW); YING-JIE HUANG, New Taipei (TW)

(21) Appl. No.: 18/947,666

(22) Filed: Nov. 14, 2024

(30) Foreign Application Priority Data
Mar. 1, 2024 (CN) 202410234533.X

(51) Int. Cl. B23Q 1/44; F16M 13/02

(52) U.S. Cl. CPC B23Q 1/44; F16M 13/022

(57) ABSTRACT

A mounting bracket and a server having the mounting bracket are disclosed. The mounting bracket includes a supporting member, a locking member, and an unlocking member. The unlocking member can move between a locked position and an unlocked position, thereby causing deformation of the locking member, which enables the locking member to connect with or disconnect from an external component. The mounting bracket can connect the workpiece and the external component without the need for tools, which helps to reduce assembly costs and maintenance costs.

### FIELD

The subject matter herein generally relates to servers, and more particularly, to a mounting bracket and a server having the mounting bracket.

### BACKGROUND

When connecting a workpiece to external components, fasteners, such as bolts and screws, are needed, and tools for operating the fasteners are also needed, resulting in low assembly efficiency and inconvenient maintenance.

Therefore, there is room for improvement in the art.

### BRIEF DESCRIPTION OF THE DRAWINGS

Implementations of the present disclosure will now be described, by way of embodiments only, with reference to the attached figures.

FIG. 1 is a diagram showing an embodiment of a mounting bracket according to the present disclosure.

FIG. 2 is a diagram showing a partial structure of the mounting bracket of FIG. 1 in a certain state.

FIG. 3 is an enlarged view of a portion A in FIG. 2. FIG. 4 is an enlarged view of a circled portion B in FIG. 1.

FIG. 5 is a diagram showing a partial structure of the mounting bracket of FIG. 1 in another state.

FIG. 6 is a diagram showing an embodiment of a partial structure of a server according to the present disclosure.

FIG. 7 is an exploded view of the server in FIG. 6.

### DETAILED DESCRIPTION

Some embodiments of the present application will be described in detail below with reference to the drawings. It is evident that the described embodiments are merely some, rather than all, of the embodiments of the present disclosure.

It should be noted that when a component is referred to as being “fixed on” or “mounted on” another component, it may be directly on the other component or there may also be an intervening component. When a component is considered to be “set on” another component, it may be in direct contact with the other component or there may also be an intervening component. As used herein, the term “and/or” includes all and any combinations of one or more of related listed items.

Unless otherwise defined, all technical and scientific terms used herein have the same meaning as commonly understood by persons skill in the art. The terms used herein are only for the purpose of describing specific embodiments, and not intended to limit the embodiments of the present application.

In this application, descriptions such as “first”, “second” etc. are only used to distinguish between different objects, and should not be understood as indicating or implying relative importance, or as implicitly specifying the quantity, particular order, or a primary-secondary relationship of the technical features indicated.

The mention of “embodiments” in the present disclosure implies that the specific features, structures, or characteristics described in conjunction with the embodiments may be included in at least one embodiment of the present application. The appearance of this phrase in various locations in the specification does not necessarily refer to the same embodiment and is not intended to be an independent or alternative embodiment that is mutually exclusive of other embodiments. The various following embodiments may be combined with each other in the absence of conflict.

It should be noted that the thicknesses, lengths, widths, and other dimensions of various components shown in the figures of the embodiments of the present application, as well as the overall thickness, lengths, widths, and other dimensions of the integrated device, are for illustrative purposes only and should not constitute any limitation on the present application.

Some embodiments of the present application will be described in detail below with reference to the drawings.

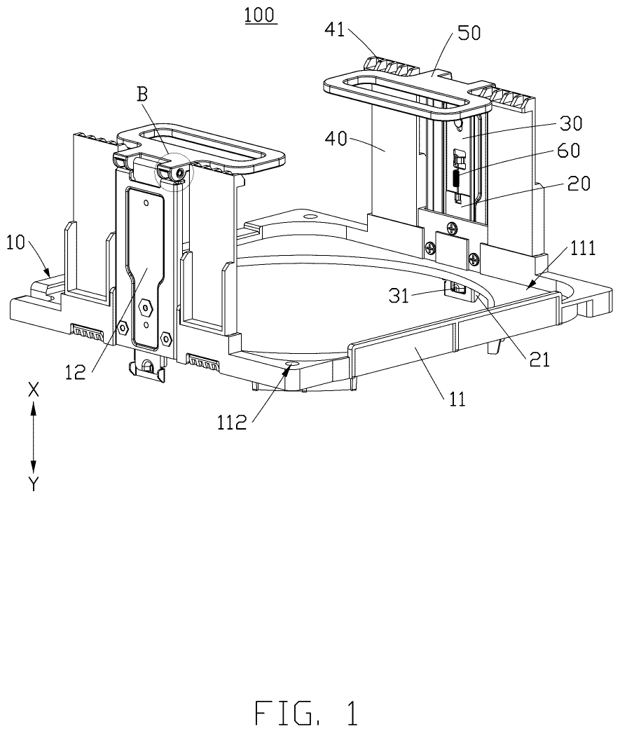

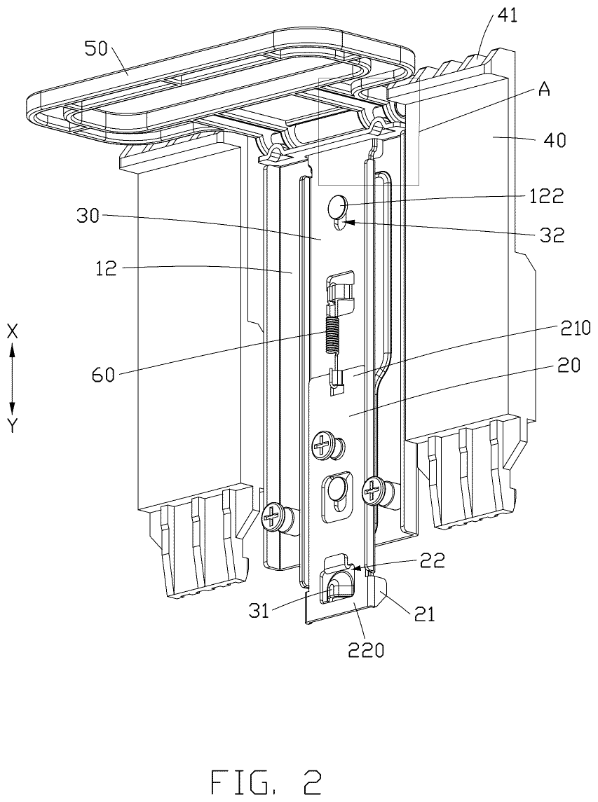

Referring to FIGS. 1 and 2, an embodiment of the present application provides a mounting bracket 100 including a supporting member 10, a locking member 20, and an unlocking member 30.

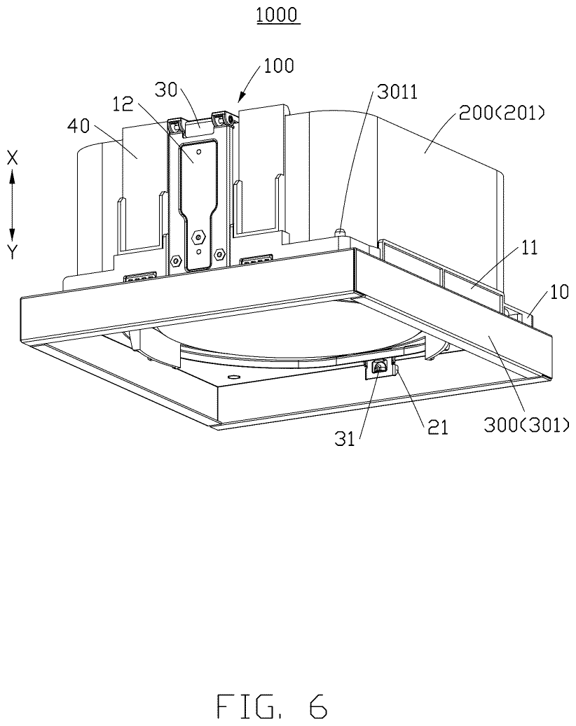

The supporting member 10 is used to support a workpiece 200 (referring to FIG. 6).

The locking member 20 is connected to the supporting member 10, and can be connected to an external component 300 (referring to FIG. 6) through a snap-fit manner.

The snap-fit between the locking member 20 and the external component 300 is simple, which is conducive to improving the efficiency of assembly and disassembly between the locking member 20 and the external component 300. In at least one embodiment, the locking member 20 includes a latching block 21, and the external component 300 defines a latching slot or includes a latching surface (not shown). The latching block 21 is used for engaging with the latching slot or latching surface. The structure of the latching block 21 is simple and easy to produce, which helps reduce manufacturing costs.

The unlocking member 30 is slidably connected to the supporting member 10, and the unlocking member 30 may be stacked on a side of the locking member 20. The unlocking member 30 can move between a locked position and an unlocked position to drive the locking member 20 to move or deform, thereby allowing the locking member 20 to switch between a locked state and an unlocked state. When the unlocking member 30 is in the locked position, the locking member 20 is connected to and locks the external component 300. When the unlocking member 30 is in the unlocked position, the locking member 20 is disengaged from and unlocks the external component 300. The locking member 20 can move or be deformed to disengage from the external component 300, which simplifies the operation and eliminates the need for using tools, thereby improving the efficiency of disassembly of the locking member 20 and the external component 300 and reducing the maintenance cost of the workpiece 200.

As shown in FIGS. 1, 2, and 5, the unlocking member 30 can move along a first direction X to reach the unlocked position, and during the sliding process, the unlocking member 30 causes the locking member 20 to deform such that the locking member 20 can be disengaged from the external component 300. The unlocking member 30 can also move along a second direction Y to reach the locked position, and during the sliding process, the locking member 20 rebounds to its original position or state, such that the locking member 20 can lock the external component 300. The locking member 20 can deform or rebound means that the locking member 20 is made of an elastic material.

In some embodiments, the first direction X is opposite to the second direction Y. It should be noted that the movement direction of the unlocking member 30 is not limited to the first direction X and the second direction Y. In other embodiments, the unlocking member may have different movement directions. For example, the movement direction of the unlocking member 30 may be a direction perpendicular to the first direction X and the second direction Y. The movement direction of the unlocking member 30 may be varied according to the connection position of the external component 300 and the mounting bracket 100. The following description is illustrated when the unlocking member 30 moves along the first direction X or the second direction Y.

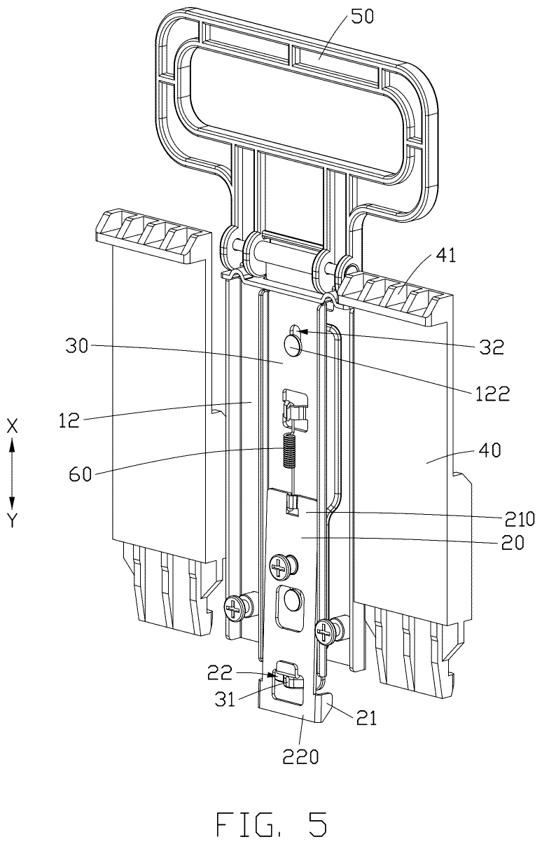

In some embodiments, one of the locking member 20 and the unlocking member 30 defines a mounting hole 22, and the other of the locking member 20 and the unlocking member 30 has a protrusion 31. As shown in FIGS. 2 and 5, in this embodiment, the locking member defines the mounting hole 22, and the unlocking member 30 has the protrusion 31. The protrusion 31 can be received in the mounting hole 22. When the unlocking member 30 moves along the first direction X, the protrusion 31 moves towards the exterior of the mounting hole 22 along the first direction X (the protrusion 31 may partially or completely move out of the mounting hole 22) to press against the portion of the locking member 20 near the mounting hole 22, driving the locking member 20 to deform, thereby the locking member 20 can be disengaged from the external component 300. When the unlocking member 30 moves along the second direction Y, the protrusion 31 moves towards the interior of the mounting hole 22 until the protrusion 31 is fully accommodated within the mounting hole 22, and the locking member 20 rebounds to allow the latching block 21 to lock the external component 300. The structure of the mounting hole 22 and the protrusion 31 is simple and easy to produce, which helps save manufacturing costs. Additionally, the simple connection between the mounting hole 22 and the protrusion 31 facilitates easier assembly of the locking member 20 and the unlocking member 30, improving production efficiency of the mounting bracket 100.

In some embodiments, the locking member 20 is integrally formed.

In some embodiments, as shown in FIGS. 2 and 5, the locking member 20 includes a first portion 210, a second portion 220, and a torsion spring (not shown in the figures). The first portion 210 is hinged to the second portion 220 and connected to the supporting member 10. The second portion 220 is connected to the external component 300 through a snap-fit manner, and the torsion spring is connected to the first portion and the second portion. When the locking member 20 switches from the locked state to the unlocked state, the first portion 210 and the second portion 220 rotate relative to each other, and the torsion spring generates an elastic force. When the locking member 20 switches from the unlocked state to the locked state, the elastic force of the torsion spring enables the locking element 20 to return to the locked state. Since the locking member 20 includes the first portion 210, the second portion 220, and the torsion spring, when one of the above three components breaks, only the broken component is needed to be replaced, which is conducive to reducing the maintenance cost of the locking member 20.

In other embodiments, the locking member 20 includes a first portion 210 and a second portion 220. The first portion 210 is connected to the supporting member 10, and the second portion 220 is hinged to the unlocking member 30. The second portion 220 is connected to the external component 300 through a snap-fit manner. When the unlocking member 30 slides relative to the supporting member 10, the unlocking member 30 pulls the second portion to rotate relative to the first portion, allowing the locking member 20 to switch between the unlocked state and the locked state. Since the locking member 20 includes the first portion 210 and the second portion 220, when one of the above two components breaks, only the broken component is needed to be replaced, which is conducive to reducing the maintenance cost of the locking member 20.

In some embodiments, when the workpiece 200 is placed on the supporting member 10, the workpiece 200 may be connected to the supporting member 10 such as by adhesive bonding, snap-fit, insertion, magnetic adsorption, thereby enhancing the stability of the connection between the workpiece 200 and the external component 300.

As shown in FIG. 1, in some embodiments, the supporting member 10 defines an installation groove 111, and the workpiece 200 is at least partially accommodated in the installation groove 111. The sidewalls of the installation groove 111 can limit the movement of the workpiece 200, thereby improving the stability of the workpiece 200 on the supporting member 10, and thus improving the stability of the connection between the workpiece 200 and the external component 300.

In some embodiments, when the workpiece 200 is placed in the installation groove 111, the workpiece 200 presses against the sidewalls of the installation groove 111, thereby generating a damping force between the workpiece 200 and the sidewalls. Therefore, the possibility of the workpiece 200 separating from of the installation groove 111 is reduced, thereby improving the stability of the workpiece 200 on the supporting member 10, and thus improving the stability of the connection between the workpiece 200 and the external component 300.

In some embodiments, an elastic material layer, such as a silicone layer or a rubber layer, is attached to the sidewalls of the installation groove 111. When the workpiece 200 is placed in the installation groove 111, the workpiece 200 presses against the elastic material layer, thereby generating the damping force between the workpiece 200 and the elastic material layer. The elastic material layer not only increases the damping applied to the workpiece 200 and improve the stability of the workpiece 200, but also reduces the damages to the sidewalls of the workpiece 200.

As shown in FIGS. 1, 2, and 5, in some embodiments, the mounting bracket 100 further includes a fixing member 40. The fixing member 40 is connected to the supporting member 10 and includes a limiting portion 41. The limiting portion 41 is connected to a top surface of the workpiece 200 to press the workpiece 200 against the supporting member 10, thereby improving the stability of the workpiece 200 on the supporting member 10, and thus improving the stability of the connection between the workpiece 200 and the external component 300.

Furthermore, the fixing member 40 further includes a fixing member body, and the limiting portion 41 is disposed at an end of the fixing member body. The height of the fixing member body is adjustable, so that the fixing member 40 can adapt to workpieces 200 of different heights, which is beneficial for making the mounting bracket 100 compatible with different usage scenarios.

Furthermore, the fixing member body includes an outer sleeve and an inner sleeve (not shown in the figures). The inner sleeve is connected to the limiting portion 41, while the outer sleeve defines an accommodation space where the inner sleeve is slidably inserted. The outer sleeve also defines a limiting hole communicating with the accommodation space, and the inner sleeve includes a protruding button for engaging with the limiting hole. By altering the relative position between the inner sleeve and the outer sleeve, the height of the fixing member body can be adjusted. When the protruding button is accommodated within the limiting hole, the relative position between the outer sleeve and the inner sleeve is fixed. This configuration results in a simple and reliable structure for the fixing member body.

As shown in FIG. 6, in some embodiments, the workpiece 200 may be in contact with the supporting member 10. The relative position between the workpiece 200 and the supporting member 10 is fixed by the external component 300. For instance, the external component 300 may include a first connecting portion and a second connecting portion, and the locking member 20 is connected to the first connecting portion. After positioning the workpiece 200 on the supporting member 10, the second connecting portion is connected to the first connecting portion. The second connecting portion is in contact with the workpiece 200 and presses the workpiece 200 against the supporting member 10. Therefore, there is no need to fix the workpiece 200 to the supporting member 10, simplifying the operational steps and enhancing the efficiency of assembling and disassembling the workpiece 200 and the supporting member 10.

In some embodiments, when the workpiece 200 is positioned on the supporting member 10, the workpiece 200 may be electrically connected to the locking member 20. When the locking member 20 engages with the external component 300, the locking element 20 is also electrically connected to the external component 300. This facilitates the electrical connection between the workpiece 200 and the external component 300, reducing the complexity of wiring.

In some embodiments, the workpiece 200 includes a first PIN, and the locking member 20 includes a first contact point. When the workpiece 200 is positioned on the supporting member 10, the first PIN is in contact with and electrically connected to the first contact point, thereby electrically connecting the workpiece 200 to the locking member 20. The locking member 20 also includes a second contact point electrically connected to the first contact point, and the external element 300 includes a second PIN. When the locking member 20 engages with the external component 300, the second PIN is in contact with and electrically connects to the second contact point. The first PIN, the first contact point, the second PIN, and second contact point are structurally simple and easy to manufacture and assemble.

In some embodiments, the first contact point and the second contact point are formed by elastic metal sheets disposed on the locking member 20. The elastic metal sheets can reduce the likelihood of the first PIN (the second PIN) disconnecting from the first contact point (the second contact point), thereby enhancing the stability of the electrical connection between the workpiece 200 and the external component 300.

In some embodiments, a flexible wire is connected to the elastic metal sheet forming the first contact point and the elastic metal sheet forming the second contact point. This allows for easy repositioning of the flexible wire, reducing the complexity of wiring.

In some embodiments, when the workpiece 200 is positioned on the supporting member 10, the workpiece 200 may be electrically connected to the carrier 10. When the locking member 20 engages with the external component 300, the supporting member 10 is electrically connected to the external component 300. This facilitates the electrical connection between the workpiece 200 and the external component 300, reducing the complexity of wiring.

In some embodiments, the workpiece 200 includes a third PIN, and the supporting member 10 includes a third contact point. When the workpiece 200 is positioned on the supporting member 10, the third PIN is in contact with and electrically connected to the third contact point, thereby electrically connecting the workpiece 200 to the supporting member 10. The supporting member 10 also includes a fourth contact point electrically connected to the third contact point, and the external component 300 includes a fourth PIN. When the locking member 20 engages with the external component t 300, the fourth PIN is in contact with and electrically connected to the fourth contact point. The third PIN, the third contact point, the fourth PIN, and the fourth contact point are structurally simple and easy to manufacture and assemble.

In some embodiments, the third contact point and the fourth contact point are formed by elastic metal sheets disposed on the supporting member 10. The elastic metal sheets can reduce the likelihood of the third PIN (the fourth PIN) disconnecting from the third contact point (the fourth contact point), thereby enhancing the stability of the electrical connection between the workpiece 200 and the external component 300.

In some embodiments, a flexible wire is connected to the elastic metal sheet forming the third contact point and the elastic metal sheet forming the fourth contact point. The position of the flexible wire can be easily changed, which reduces the difficulty of wiring.

It is easy to imagine that in the aforementioned embodiments, the positions of the first PIN and the first contact point, the second PIN and the second contact point, the third PIN and the third contact point, as well as the fourth PIN and the fourth contact point can be interchangeable to achieve the same effect.

As shown in FIGS. 1 and 6, in some embodiments, the supporting member 10 includes a base 11 and a mounting portion 12. The base 11 and the mounting portion 12 are separately configured. The base 11 is used to support the workpiece 200, while the mounting portion 12 is used to install the locking member 20 and the unlocking member 30. This allows for connecting the locking member 20 and the unlocking member 30 to the mounting portion 12 before attaching the mounting portion 12 to the base 11, reducing assembly difficulty and saving assembly costs.

In other embodiments, the base 11 and the mounting portion 12 are integrally formed, which facilitates reducing the difficulty of manufacturing the supporting member 10 and saving costs.

In some embodiments, the supporting member 10 and the locking member 20 are integrally formed. The step of assembling the supporting member 10 and the locking member 20 are eliminated, thereby enhancing the assembly efficiency of the mounting frame 100.

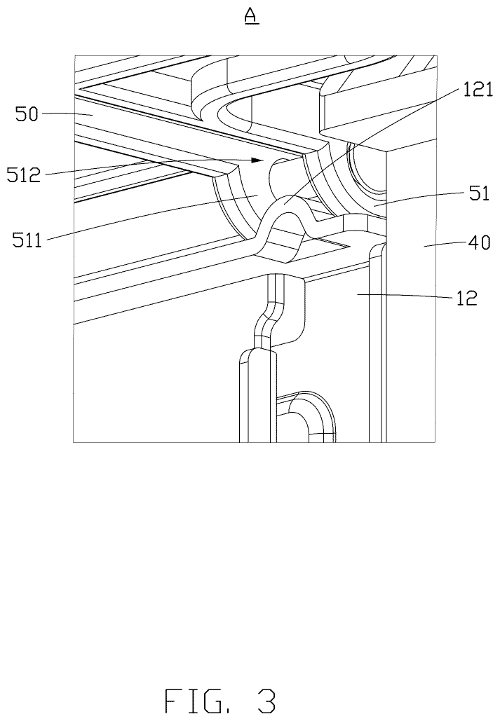

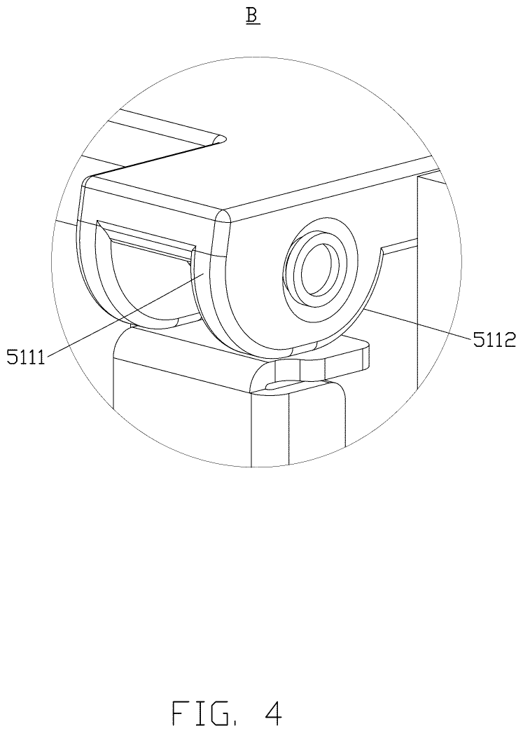

As shown in FIGS. 1 to 3, in some embodiments, the mounting bracket 100 further includes a handle 50. The handle 50 is rotatably connected to the unlocking member 30 and includes an arcuate surface 511 that is in contact with the mounting portion 12. As shown in FIGS. 3 and 4, the arcuate surface 511 has a first contact area 5111 and a second contact area 5112. From the first contact area 5111 to the second contact area 5112, the radius of curvature of the arcuate surface 511 gradually changes. In this embodiment, the radius of curvature of the first contact area is greater than that of the second contact area. The handle 50 has a first positional state where the first contact area 5111 is in contact with the mounting portion 12 and a second positional state where the second contact area 5112 is in contact with the mounting portion 12. The handle 50 can rotate between the first positional state and the second positional state. When the handle is in the first positional state, the unlocking member 30 is in an unlocked position. When the handle is in the second positional state, the unlocking member 30 is in a locked position. The handle 50 allows the operator to easily apply force to the unlocking member 30, reduces the difficulty of moving the unlocking member 30, enhances the efficiency of disassembly of the locking member 20 and the external component 300, and thereby lowering the maintenance cost of the workpiece 200.

As shown in FIG. 3, in some embodiments, the handle 50 includes a connecting portion 51. The arcuate surface 511 is formed on the connecting portion 51. One of the connecting portion 51 and the supporting member 10 defines a guide groove 512, while the other of the connecting portion 51 and the supporting member 10 includes a guide protrusion 121. In this embodiment, the connecting portion 51 defines the guide groove 512, and the supporting member 10 includes the guide protrusion 121. The guide protrusion 121 is received in the guide groove 512 to restrict axial movement of the handle 50. The engagement between the guide protrusion 121 and the guide groove 512 enhances the stability of the rotation of the handle and optimize the user's operational experience.

As shown in FIGS. 1, 2, and 5, in some embodiments, the mounting bracket 100 further includes an elastic member 60 connecting the handle 50 and the supporting member 10. When the handle 50 is in the first positional state, the elastic member 60 has a first deformation amount; when the handle 50 is in the second positional state, the elastic member 60 has a second deformation amount. The first deformation amount is greater than the second deformation amount. That is, the elongated length of the elastic member 60 in the first positional state is greater than the elongated length of the elastic member 60 in the second position state. During the transition of the handle 50 from the first positional state to the second positional state, the elastic member 60 applies a tensile force to the handle 50, enabling the handle 50 to move towards the second positional state under the tensile force without requiring the user to apply force continuously, thereby optimizing the user's experience. Additionally, under the action of the elastic member 60, the handle 50 and the supporting member 10 can jointly clamp the workpiece 200, which helps improve the stability of the workpiece 200 on the supporting member 10. Furthermore, when the handle 50 moves towards the first positional state, the handle 50 drives the unlocking member 30 to move towards the unlocked position, so that while the handle 50 releases the restriction on the workpiece 200, the locking member 20 disconnects from the external component 300. At this point, the workpiece 200 can be removed from the supporting member 10, and the locking member 20 can be removed from the external component 300, which improves the efficiency of disassembly of the workpiece 200, the mounting bracket 100, and the external component 300.

In some embodiments, the elastic member 60 is connected to the unlocking member 30 and the supporting member 10, thereby reducing the length of the elastic member 60 and saving costs.

In some embodiments, the locking member 20 has a first inclined surface (not shown in the figures), and the unlocking member 30 has a second inclined surface (not shown in the figures) that can mate with the first inclined surface. When the unlocking member 30 moves from the locked position to the unlocked position, the second inclined surface moves along the first inclined surface and drives deformation of the locking member 20.

In some embodiments, one of the supporting member 10 and the unlocking member 30 includes a guide post 122, and the other defines a guide hole 32. As shown in FIGS. 2 and 5, in this embodiment, the supporting member 10 includes the guide post 122, and the unlocking member 30 defines the guide hole 32. The guide post 122 passes through the guide hole 32, and the unlocking member 30 is slidably connected to the supporting member 10 through the engagement of the guide post 122 and the guide hole 32. The simple structure of the guide post 122 and the guide hole 32 reduces the difficulty of assembling the unlocking member 30 and the supporting member 10, and improve production efficiency of the mounting bracket 100. At the same time, the engagement of the guide post 122 and the guide hole 32 can guide the sliding direction of the unlocking member 30, thus improving the stability of the unlocking member 30 during movement.

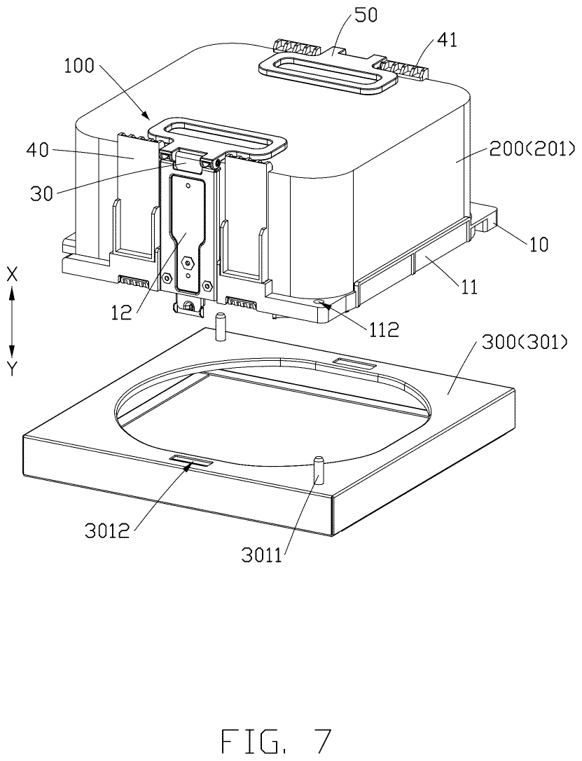

As shown in FIGS. 1 and 7, in some embodiments, the supporting member 10 defines a positioning hole 112, and the external component 300 includes a positioning post 3011. The positioning post 3011 can be engaged in the positioning hole 112 to locate the supporting member 10 and quickly find the position of the mounting bracket 100 relative to the external component 300, thus improving the efficiency of connecting the mounting bracket 100 with the external component 300.

In some embodiments, the supporting member 10 includes the positioning post 3011, and the external component 300 defines the positioning hole 112. The positioning post 3011 can be engaged in the positioning hole 112 to locate the supporting member 10 and quickly find the position of the mounting bracket 100 relative to the external component 300, thus improving the efficiency of connecting the mounting bracket 100 with the external component 300.

As shown in FIG. 7, in some embodiments, the external component 300 defines a latching hole 3012. After the latching block 21 passes through the latching hole 3012, the latching block 21 contacts with the external component 300. At this point, the surface of the external component 300 in contact with the latching block 21 forms the aforementioned latching surface.

In other embodiments, the locking member 20 defines the latching slot, and the external component 300 includes the latching block 21 for engaging with the latching slot. The structure of the latching slot is simple and easy to produce, which helps reduce manufacturing costs.

As shown in FIG. 1, in some embodiments, the quantity of the locking member 20 and the unlocking member 30 is both two. One locking member 20 and one unlocking member 30 are disposed on one side of the supporting member 10, and the other locking member 20 and the other unlocking member 30 are disposed on the other side of the supporting member 10. Thus, both sides of the supporting member 10 are connected to the external element 300, thereby enhancing the stability of the connection between the mounting bracket 100 and the external component 300.

As shown in FIGS. 6 and 7, an embodiment of the present application also provides a server 1000, including a cabinet 301 (only the portion of the cabinet 301 connected to the mounting bracket 100 is shown in FIGS. 6 and 7), a fan module 201, and the mounting bracket 100 according to any of the aforementioned embodiments. The fan module 201 is disposed on the supporting member 10, and the locking member 20 is connected to the cabinet 301 through a snap-fit manner. The fan module 201 is connected to the cabinet 301 through the mounting bracket 100, and the assembly and disassembly among the cabinet 301, the fan module 201, and the mounting bracket 100 do not require external tools. The operation is simple, which helps improve the efficiency of connecting and disconnecting between the fan module 201 and the cabinet 301, thereby reducing the assembly and maintenance costs of the server 1000.

The above descriptions are some specific embodiments of the present application, but the actual application process cannot be limited only to these embodiments. For those of ordinary skill in the art, other modifications and changes made according to the technical concept of the present application should all belong to the protection scope of the present application.

What is claimed is:

1. A mounting bracket comprising:
a supporting member configured for supporting a workpiece;
a locking member connected to the supporting member, wherein the locking member is configured to connect to an external component through a snap-fit manner; and
an unlocking member slidably connected to the supporting member, wherein the unlocking member is configured to move between a locked position and an unlocked position, such that the locking member deforms, when the unlocking member is in the locked position, the locking member is engaged to the external component, and when the unlocking member is in the unlocked position, the locking member is disengaged from the external component.

2. The mounting bracket of claim 1, further comprising:
a handle rotatably connected to the unlocking member, wherein the handle comprises an arcuate surface in contact with the supporting member, the arcuate surface comprises a first contact area and a second contact area, a radius of curvature of the arcuate surface changes from the first contact area to the second contact area, and a radius of curvature of the first contact area is greater than a radius of curvature of the second contact area,
the handle has a first positional state where the first contact area is in contact with the supporting member and a second positional state where the second contact area is in contact with the supporting member, the handle is configured to rotate between the first positional state and the second positional state, and
when the handle is in the first positional state, the unlocking member is in the unlocked position; when the handle is in the second positional state, the unlocking member is in the locked position.

3. The mounting bracket of claim 2, further comprising:
an elastic member 60 connected to the handle and the supporting member, wherein when the handle is in the first positional state, the elastic member has a first deformation amount, when the handle is in the second positional state, the elastic member has a second deformation amount, and the first deformation amount is greater than the second deformation amount.

4. The mounting bracket of claim 2, wherein:
the handle comprises a connecting portion, the arcuate surface is formed on the connecting portion; and
one of the connecting portion and the supporting member defines a guide groove, another of the connecting portion and the supporting member comprises a guide protrusion, and the guide groove receives the guide protrusion limit an axial movement of the handle.

5. The mounting bracket of claim 1, wherein:
the locking member defines a mounting hole, the unlocking member further comprises a protrusion 31, and the protrusion is configured to be received in the mounting hole;
when the unlocking member moves to the unlocked position, the protrusion is configured to move towards an exterior of the mounting hole, such that the locking member deforms; and
when the unlocking member moves to the locked position, the protrusion is further configured to move into the mounting hole.

6. The mounting bracket of claim 1, wherein:
the unlocking member defines a mounting hole 22, the locking member comprises a protrusion, the protrusion is configured to be received in the mounting hole;
when the unlocking member moves to the unlocked position, the protrusion is configured to move towards an exterior of the mounting hole, such that the locking member deforms; and
when the unlocking member moves to the locked position, the protrusion is further configured to move into the mounting hole.

7. The mounting bracket of claim 1, wherein the supporting member comprises a guide post, the unlocking member defines a guide hole, the guide post extends through the guide hole, such that the unlocking member is slidably connected to the supporting member.

8. The mounting bracket of claim 1, wherein the unlocking member comprises a guide post, the supporting member defines a guide hole, the guide post extends through the guide hole, such that the unlocking member is slidably connected to the supporting member.

9. The mounting bracket of claim 1, wherein the supporting member defines a positioning hole, the external component comprises a positioning post, and the positioning post is configured to engage with the positioning hole.

10. The mounting bracket of claim 1, wherein the external component defines a positioning hole, the supporting member comprises a positioning post, and the positioning post is configured to engage with the positioning hole.

11. The mounting bracket of claim 1, further comprising:
a fixing member connected to the supporting member, wherein the fixing member comprises a limiting portion, the limiting portion is configured to connect to a top surface of the workpiece, such that the workpiece presses against the supporting member.

12. The mounting bracket of claim 1, wherein the supporting member defines an installation groove, and the workpiece is at least partially accommodated in the installation groove.

13. The mounting bracket of claim 12, wherein the supporting member comprises a base and a mounting portion, the installation groove is defined on the base, the base is configured to support the workpiece, and the locking member and the unlocking member are configured to install on the mounting portion.

14. The mounting bracket of claim 1, further comprising two locking members and two unlocking members, wherein one of the two locking members and one of the two unlocking members are arranged on one side of the supporting member, and the other of the two locking members and the other of the two unlocking members are arranged on another side of the supporting member.

15. A server comprising:
a mounting bracket comprising:
a supporting member;
a locking member connected to the supporting member, wherein the locking member is connected to an external component through a snap-fit manner; and
an unlocking member slidably connected to the supporting member, wherein the unlocking member is configured to move between a locked position and an unlocked position, such that the locking member deforms, when the unlocking member is in the locked position, the locking member is engaged to the external component, and when the unlocking member is in the unlocked position, the locking member is disengaged from the external component;
a cabinet connected to the locking member through a snap-fit manner, wherein the cabinet is the external component; and
a workpiece arranged on the supporting member.

16. The server of claim 15, wherein:
the mounting bracket further comprises a handle rotatably connected to the unlocking member, the handle comprises an arcuate surface in contact with the supporting member, the arcuate surface comprises a first contact area and a second contact area, a radius of curvature of the arcuate surface gradually changes from the first contact area to the second contact area, and a radius of curvature of the first contact area is greater than a radius of curvature of the second contact area,
the handle has a first positional state where the first contact area is in contact with the supporting member and a second positional state where the second contact area is in contact with the supporting member, the handle is configured to rotate between the first positional state and the second positional state, and
when the handle is in the first positional state, the unlocking member is in the unlocked position; when the handle is in the second positional state, the unlocking member is in the locked position.

17. The server of claim 16, wherein the mounting bracket further comprises an elastic member connected to the handle and the supporting member, when the handle is in the first positional state, the elastic member has a first deformation amount, when the handle is in the second positional state, the elastic member has a second deformation amount, and the first deformation amount is greater than the second deformation amount.

18. The server of claim 16, wherein:
the handle comprises a connecting portion, the arcuate surface is formed on the connecting portion; and
one of the connecting portion and the supporting member defines a guide groove, another of the connecting portion and the supporting member comprises a guide protrusion, and the guide protrusion is received in the guide groove to limit an axial movement of the handle.

19. The server of claim 15, wherein:
the locking member defines a mounting hole, the unlocking member further comprises a protrusion, and the protrusion is configured to be received in the mounting hole;
when the unlocking member moves to the unlocked position, the protrusion is configured to move towards an exterior of the mounting hole, such that the locking member deforms; and
when the unlocking member moves to the locked position, the protrusion is further configured to move into the mounting hole.

20. The server of claim 15, wherein:
the unlocking member defines a mounting hole, the locking member comprises a protrusion, the protrusion is configured to be received in the mounting hole;
when the unlocking member moves to the unlocked position, the protrusion moves towards an exterior of the mounting hole, such that the unlocking member deforms; and
when the unlocking member moves to the locked position, the protrusion is further configured to move into the mounting hole.
